(19) United States
(12) Patent Application Publication
(10) Pub. No.: US 2016/0313138 A1
(43) Pub. Date: Oct. 27, 2016

(54) SYSTEM AND METHOD FOR DYNAMICALLY OPTIMIZING MAP DESTINATION ROUTING PERFORMANCE

(71) Applicant: YANDEX EUROPE AG, Luzern (CH)

(72) Inventor: Aleksandr Ustinovich CHUPAKHIN, Tim, Kursk Region (RU)

(21) Appl. No.: 15/100,330

(22) PCT Filed: Jan. 16, 2015
(86) PCT No.: PCT/IB2015/050349

§ 371 Date: May 30, 2016

(30) Foreign Application Priority Data
Jul. 16, 2014 (RU) 2014128981

(51) Int. Cl. G01C 21/36; H04L 29/08

(52) U.S. Cl. CPC G01C 21/3667; H04L 67/12

(57) ABSTRACT

Disclosed are systems and methods for dynamically optimizing map service performance and, particularly, map destination routing performance. An example system includes a map application module configured to receive at least a start location and an end location for a route, and transmit to the server a request for route information from the start location to the end location. The map application module may then receive from the server the route information, and generate a route on the map between the start location and the end location based on the route information. The map application module may then receive a request to change the route, and transmit to the server one or more requests for updated route information based on the requested change to the route, wherein the one or more requests are transmitted to the server periodically at a frequency that is based on characteristics of the client device.

### CROSS-REFERENCE

The present application claims convention priority to Russian Patent Application No. 2014128981, filed Jul. 16, 2014, entitled “SYSTEM AND METHOD FOR DYNAMICALLY OPTIMIZING MAP DESTINATION ROUTING PERFORMANCE” which is incorporated by reference herein in its entirety.

### TECHNICAL FIELD

The disclosure relates generally to the field of mapping systems, and more specifically to the systems, methods and computer program products for dynamically optimizing map service performance.

### BACKGROUND

Digital map systems are utilized by a wide variety of devices, such as mobile phones, desktop computers, hand held Global Positioning System (GPS) units, etc. Map data may be stored on a remote server before being accessed by and displayed on the various devices. The devices may use either a stand-alone application or a web browser to access the map data.

The different devices accessing the map data vary greatly in their characteristics, such as the software being used to access the map data, the processing power of the device, the random access memory (RAM) capacity of the device, the speed and throughput of the internet connection, etc. The server providing the map data to these devices does so with consistent quality and detail, with disregard for the specific characteristics of the device requesting the map data. Thus, the device's performance in rendering the map data depends on the device's characteristics. For example, a device with a slow internet connection, a high processor load, and little memory will load the map data slowly and ineffectively, whereas a device with a fast internet connection, a low processor load, and a lot of available memory will load the map data quickly and effectively. As such, the disparity in the characteristics between devices results in an inconsistent and sometimes disappointing digital map service experience by the users of these devices. Therefore, there exists an unmet need in the art for systems and methods for dynamically optimizing map service performance in devices based on the respective devices' characteristics.

### SUMMARY

Disclosed are systems, methods and computer program products for dynamically optimizing map service performance and, particularly, map destination routing performance.

According to one example, a method for dynamically optimizing map destination routing performance includes initiating on a client device a program associated with a map service including an interactive map, wherein the map service is provided at least in part by a server; receiving at least a start location and an end location for a route; transmitting to the server a request for route information from the start location to the end location; receiving from the server the route information; generating a route on the map between the start location and the end location based on the route information; receiving a request to change the route, including at least one of a change to the start location, a change to the end location, and an addition of at least one new point of interest to the route; transmitting to the server one or more requests for updated route information based on the requested change to the route, wherein the one or more requests are transmitted to the server periodically at a frequency that is based on characteristics of the client device; receiving from the server updated route information in response to the one or more requests; and generating an updated route on the map based on each instance of the updated route information received in response to the one or more requests.

In one example, the characteristics of the client device include one or more of processor type, total memory, graphics subsystem type, current processor load, current number of operations executed by the processor, available memory, and internet connection speed.

In another example, the frequency is further based on secondary characteristics including one or more of a load on the map service that is provided by the server, a time required for drawing the updated route as determined by the graphics subsystem type, a length of the updated route, a size of the updated route information.

In another example, the frequency is further based on a size of the updated route information that directly scales with a distance of the updated route.

In another example, the frequency is further based on an estimated time for the client device to process the size of the updated route information based at least on the current processor load of the client device, available memory of the client device, and a bandwidth of a connection between the client device and the server.

In another example, the frequency is further based on a queue of the requests for updated route information at the server, wherein the frequency is inversely proportional to a growth of the queue.

In another example, the frequency is determined by the server based on the characteristics of the client device and the secondary characteristics.

In another example, the method further comprises detecting an event affecting at least one of the characteristics of the client device or at least one of the secondary characteristics; determining the characteristics of the client device and the secondary characteristics upon detection of the event; and transmitting the determined characteristics of the client device and the secondary characteristics to the server.

In another example, the event includes one or more of a new application being loaded into memory, a new background process, and a change to a different type of internet connection.

According to another example, a system for dynamically optimizing map destination routing performance includes a map application module executable by a processor of a client device and configured to: initiate on the client device a program associated with a map service including an interactive map, wherein the map service is provided at least in part by a server; receive at least a start location and an end location for a route; transmit to the server a request for route information from the start location to the end location; receive from the server the route information; generate a route on the map between the start location and the end location based on the route information; receive a request to change the route, including at least one of a change to the start location, a change to the end location, and an addition of at least one new point of interest to the route; transmit to the server one or more requests for updated route information based on the requested change to the route, wherein the one or more requests are transmitted to the server periodically at a frequency that is based on characteristics of the client device; receive from the server updated route information in response to the one or more requests; and generate an updated route on the map based on each instance of the updated route information received in response to the one or more requests.

According to yet another example, a method for dynamically optimizing map destination routing performance includes receiving, by a server, from a client device a request to access a map service including an interactive map; receiving from the client device at least a start location and an end location for a route; determining a route based at least on the start location and the end location; transmitting to the client device the route information, wherein the route information facilitates the generation of the route on the map between the start location and the end location; receiving from the client device one or more requests for updated route information based on a request to change the route, including at least one of a change to the start location, a change to the end location, and an addition of at least one new point of interest to the route, wherein the one or more requests are received periodically at a frequency that is based on characteristics of the client device; and transmitting to the client device updated route information in response to the one or more requests, wherein at least one of a size of the updated route information and a frequency at which the updated route information is transmitted to the client device is based on one or more of a queue of the requests for updated route information at the server, a length of the updated route, a number of points of interest (POIs) on the updated route, and a quantity of the one or more requests for the updated route information.

In one example, the characteristics of the client device include one or more of processor type, total memory, graphics subsystem type, current processor load, current number of operations executed by the processor, available memory, and internet connection speed.

In another example, the frequency is further based on secondary characteristics including one or more of a load on the map service that is provided by the server, a time required for drawing the updated route as determined by the graphics subsystem type, a length of the updated route, a size of the updated route information.

In another example, the frequency is further based on a size of the updated route information that directly scales with a distance of the updated route.

In another example, the frequency is further based on an estimated time for the client device to process the size of the updated route information based at least on the current processor load of the client device, available memory of the client device, and a bandwidth of a connection between the client device and the server.

In another example, the frequency is further based on a queue of the requests for updated route information at the server, wherein the frequency is inversely proportional to a growth of the queue.

In another example, the frequency is determined by the server based on the characteristics of the client device and the secondary characteristics.

In another example, wherein the method further includes receiving from the client device updated characteristics in response to a detected event affecting at least one of the characteristics of the client device or at least one of the secondary characteristics.

In another example, the event includes one or more of a new application being loaded into memory, a new background process, a change to a different type of internet connection.

According to yet another example, a system for dynamically optimizing map destination routing performance includes a map service module executable by a processor of a server and configured to: receive from a client device a request to access a map service including an interactive map; receive from the client device at least a start location and an end location for a route; determine a route based at least on the start location and the end location; transmit to the client device the route information, wherein the route information facilitates the generation of the route on the map between the start location and the end location; receive from the client device one or more requests for updated route information based on a request to change the route, including at least one of a change to the start location, a change to the end location, and an addition of at least one new point of interest to the route, wherein the one or more requests are received periodically at a frequency that is based on characteristics of the client device; and transmit to the client device updated route information in response to the one or more requests, wherein at least one of a size of the updated route information and a frequency at which the updated route information is transmitted to the client device is based on one or more of a queue of the requests for updated route information at the server, a length of the updated route, a number of points of interest (POIs) on the updated route, and a quantity of the one or more requests for the updated route information.

The above simplified summary of example aspects serves to provide a basic understanding of the invention. This summary is not an extensive overview of all contemplated aspects, and is intended to neither identify key or critical elements of all aspects nor delineate the scope of any or all aspects of the invention. Its sole purpose is to present one or more aspects in a simplified form as a prelude to the more detailed description of the invention that follows. To the accomplishment of the foregoing, the one or more aspects of the invention include the features described and particularly pointed out in the claims.

### BRIEF DESCRIPTION OF THE DRAWINGS

The accompanying drawings, which are incorporated into and constitute a part of this specification, illustrate one or more example aspects of the invention and, together with the detailed description, serve to explain their principles and implementations.

FIG. 1 is a diagram illustrating an example aspect of a system for dynamically optimizing map service performance according to one aspect of the invention.

FIG. 2 is a diagram illustrating an example aspect of a web browser displaying a map request entry webpage of a system for dynamically optimizing map service performance according to one aspect of the invention.

FIG. 3 is a diagram illustrating an example aspect of a map webpage of a system for dynamically optimizing map service performance according to one aspect of the invention.

FIG. 4 is a flow diagram illustrating an example method for dynamically optimizing map tiles according to one aspect of the invention.

FIG. 5 is a flow diagram illustrating an example method for dynamically optimizing map tiles according to one aspect of the invention.

FIG. 6 is a flow diagram illustrating an example method for dynamically optimizing map scaling animation according to one aspect of the invention.

FIG. 7 is a flow diagram illustrating an example method for dynamically optimizing map scaling animation according to one aspect of the invention.

FIGS. 8A-C are diagrams illustrating an example aspect of a map webpage of a system for dynamically optimizing map destination routing performance according to one aspect of the invention.

FIG. 9 is a flow diagram illustrating an example method for dynamically optimizing map destination routing performance according to one aspect of the invention.

FIG. 10 is a flow diagram illustrating an example method for dynamically optimizing map destination routing performance according to one aspect of the invention.

FIG. 11 is a diagram illustrating an example of a general-purpose computer system on which are implemented the systems and methods for dynamically optimizing map service performance in accordance with aspects of the invention.

### DETAILED DESCRIPTION

Example aspects of the present invention are described herein in the context of systems, methods and computer program products for dynamically optimizing map service performance. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same items.

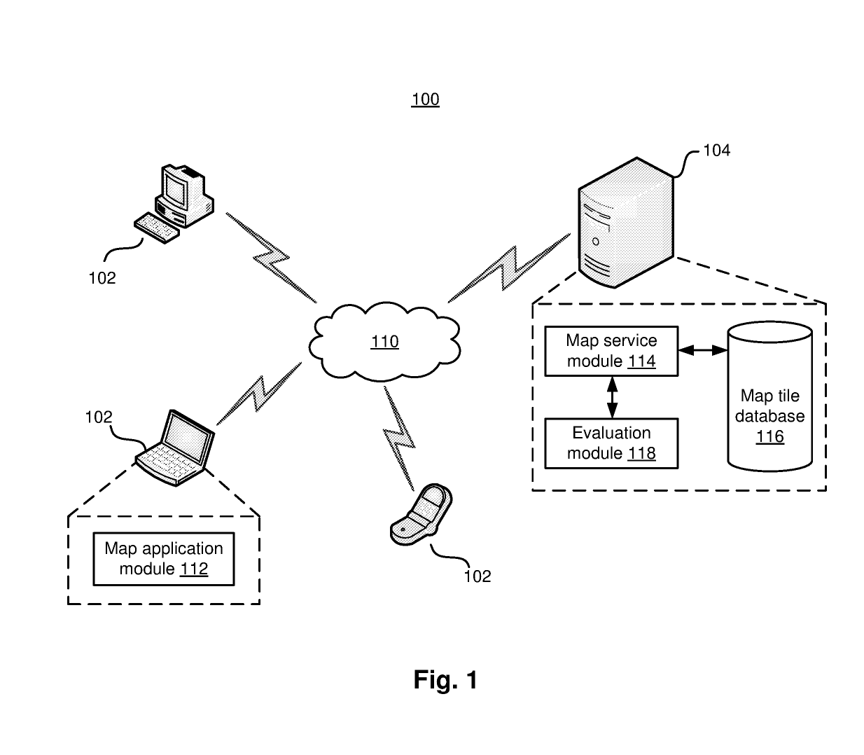

FIG. 1 depicts an example system 100 for dynamically optimizing map service performance according to one aspect of the invention. The system 100 may include various electronic user devices 102, such as a mobile device, a desktop computer, a laptop, etc. In one aspect, a device 102 may include a map application module 112. The device 102 may be connected to a network 110, such as the Internet, via a wired or wireless connection. Also connected to the network 110 may be a map server 104. In one aspect, the map server 104 may host one or more map services that provide geographic map data to various user devices, such as device 102. In one aspect, the map server 104 may include a map service module 114, a map tile database 116, and an evaluation module 118. The functionality of each of the modules of the device 102 and the map server 104 will be described in greater detail below.

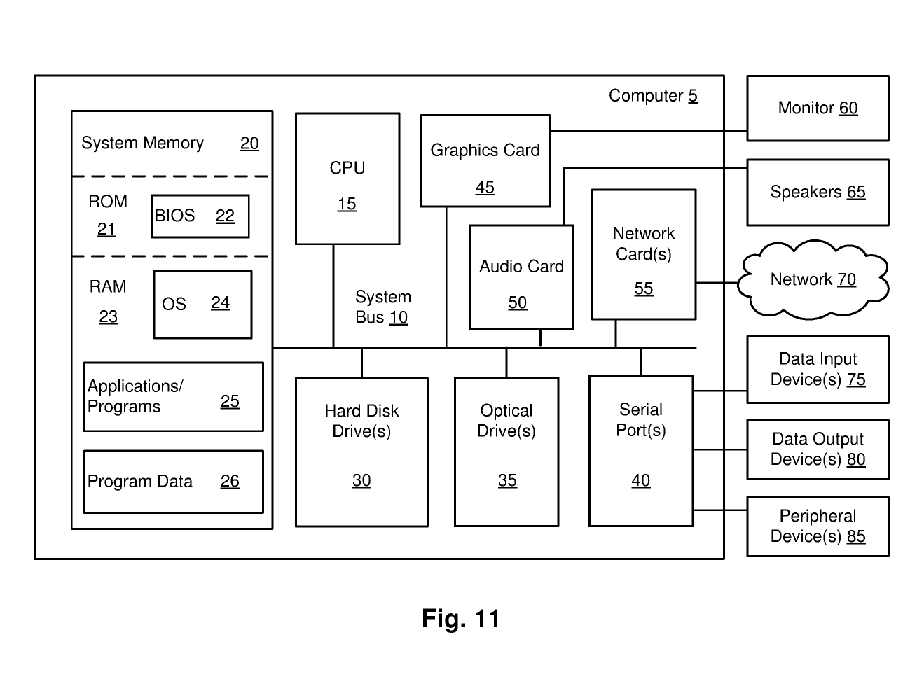

The term “module” as used herein means a real-world device, apparatus, or arrangement of modules implemented using hardware, such as by an application specific integrated circuit (ASIC) or field-programmable gate array (FPGA), for example, or as a combination of hardware and software, such as by a microprocessor system and a set of instructions to implement the module's functionality, which (while being executed) transform the microprocessor system into a special-purpose device. A module can also be implemented as a combination of the two, with certain functions facilitated by hardware alone, and other functions facilitated by a combination of hardware and software. In certain implementations, at least a portion, and in some cases, all, of a module can be executed on the processor of a general purpose computer (such as the one described in greater detail in FIG. 11 below). Accordingly, each module can be realized in a variety of suitable configurations, and should not be limited to any particular implementation exemplified herein.

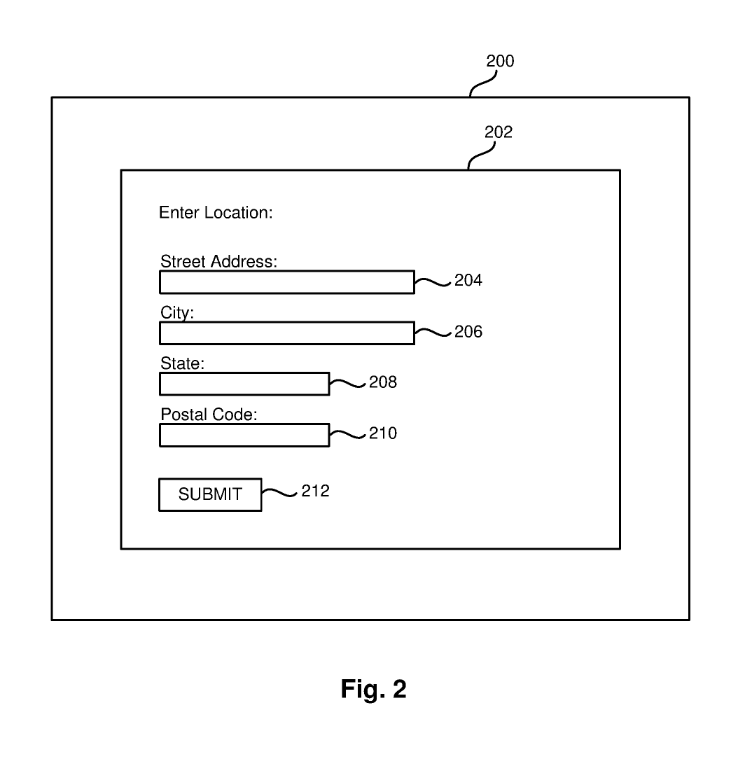

The map application module 112 of the device 102 shown in FIG. 1 may be a web browser or any application that allows a user to access a map service, such as the map service provided by the map server 104, via the network 110. For example, FIG. 2 illustrates an example aspect of such a web browser with a user interface 200 displaying a map request entry webpage 202 of a system for dynamically optimizing map service performance according to one aspect of the invention. The map request entry webpage 202 may be hosted and provided by the map service module 114. As shown in FIG. 2, the map request entry webpage 202 may include a number of text fields for entering specific location information, such as street address 204, city 206, state 208, and postal code (e.g., zip code) 210. After entering the desired location to be mapped, the user may then request a map from the map server 104 by selecting a “submit” button 212. A map image may then be generated at the map server 104, transmitted to the user's device 102, and eventually displayed on the web browser user interface 200 in a map webpage.

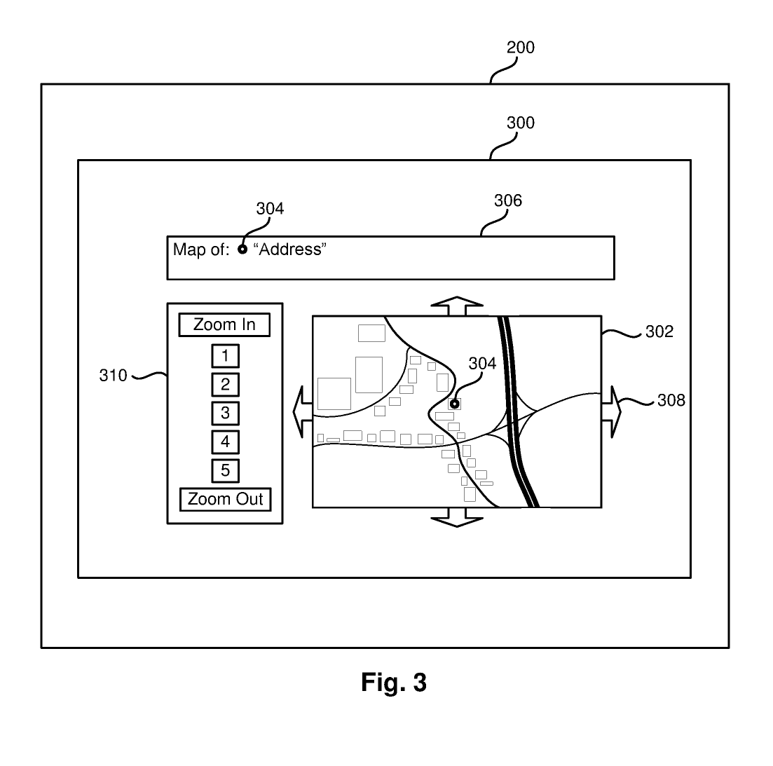

FIG. 3 illustrates an exemplary map webpage 300 on the web browser user interface 200. As shown in FIG. 3, the map webpage 300 may display the results of the map request from FIG. 2. The displayed information may consist of a map image 302, which depicts the requested location and surrounding area. The requested location may be identified on the map image 302 by an address icon 304, and the address icon 304 may be located in the center of map image 302. The requested location and address icon 304 may also be displayed in a map legend window 306 within map webpage 300.

The map webpage 300 may also display buttons or other user interface objects that may be selected to control the manner in which the map image 302 is displayed. For example, as shown in FIG. 3, zoom control objects 310 may be provided to allow the user to “zoom in” or “zoom out” and thereby affect the displayed scale of map image 302 accordingly, typically while retaining the desired location marked by address icon 304 at the center of the image. The user may also change the scale of the map image 302 with a peripheral control device, such as by scrolling a mouse wheel. The map scaling from one zoom level to another may be animated such that a user perceives a gradual “zooming in” or “zooming out” animation (at a predetermined frame rate) when changing the scale of the map image 302. Also, direction buttons or other similar user interface objects, such as “right arrow” direction button 308, may be provided to allow the user to “pan” the image, such as by displaying more of the map information that was previously hidden because it was beyond the “eastern” boundary of map image 308, while shifting and hiding a corresponding portion of the previously displayed “western” portion of the map information. As shown in FIG. 3, such image control objects may be displayed outside the boundary area of the map image 302 or alternatively may be displayed within the map image 302. The user may also “click and drag” the map image 302 to “pan” the image in any desired direction.

When image control objects (e.g., zoom control objects 310 or direction button 308 shown in FIG. 3) are selected, the device 102 may transmit a request (e.g,. an HTTP request) to the map server 104, which may then respond to the request with a new image containing the new map information to be displayed at the selected zoom level.

Specifically, in the exemplary system, as shown in FIG. 1, the map application module 112 may send a request containing location information for a requested map image to the map server 104. The request may consist of location data received via the web browser user interface 200 through the map request entry webpage 202, as illustrated in FIG. 2. For example, a user may enter the following desired location to be mapped: 1201 Main St., Springfield, N.Y., 14850. The user may then request a map of the location by selecting a “submit” button 212, and this selection event eventually causes the request to be transmitted (directly or indirectly) from the map application module 112 to the map server 104.

The map service module 114 of the map server 104 may receive the request and in response may transmit instructions to the map application module 112 of the device 102 to assess various characteristics of the device 102. For example, the instructions may require the device 102 to assess its static characteristics (e.g., processor type, total memory, graphics subsystem) and dynamic characteristics (e.g., current device processor load, current number of operations executed by the processor, available memory, internet connection speed/bandwidth). Upon receipt of the instructions, the map application module 112 may assess the device characteristics and transmit a message including the assessment of the characteristics to the map service module 114. In accordance with one aspect, the map service module 114 may transmit instructions to the map application module 112 to reassess the characteristics of the device 102 on a periodic basis. Alternatively or in addition, the map application module 112 may prompt the device 102 to reassess the characteristics in response to any number of events that may potentially affect the characteristics of the device 102, such as a new application being loaded into memory (e.g., user launched a different application), detection of a new background process (e.g., an e-mail application checks a server for new e-mails), the user switching the device 102 to a different type of internet connection (e.g., from 3GPP to WiFi).

Upon receipt of the message including the assessment of the characteristics, the map service module 114 may transmit the assessment of the characteristics to the evaluation module 118, which evaluates the characteristics and makes certain determinations based on the evaluation of the characteristics.

For example, in accordance with one aspect, the evaluation module 118 may determine a suitable level of quality (e.g., map tile resolution) and a suitable level of detail (e.g., map tile information) of the map tiles based on the characteristics of the device. The map tile database 116 may store map tiles that constitute the whole of the map at each zoom level, and that form the map image 302 displayed to the user within the map webpage 300. After receiving a request from a user to display a certain map location, the map service module 114 may retrieve from the map tile database 116 map tiles that correspond to the requested location at the requested zoom level. Each map tile may include a level of detail (e.g., map tile information) showing and identifying various features on the map tile, such as landscape features relevant to its scale, including cities, towns, villages, buildings, roads, railways, walkways, lakes, rivers, woodlands, points of interest, relief or terrain, three-dimensional quality of the surface, specific landforms, etc., as well as labels identifying the features. Each map tile may also include a level of quality (e.g., map tile resolution) related to graphical resolution of the various features.

After the evaluation module 118 receives the assessment of the characteristics of the device 102, it may determine, based on one or more of the characteristics, the quality and detail levels of the map tiles to be transmitted to the device 102. For example, in accordance with one aspect, the evaluation module 118 may adjust the quality level (e.g., map tile resolution) of the map tiles based on the current internet connection speed of the device 102. According to one aspect, the map tile resolution may be measured using a device pixel ratio (DPR). DPR is the ratio between logical pixels (e.g., a pixel on a web page or an image pixel) and physical pixels (e.g., pixels on the screen of the device). For example, if a physical linear resolution (e.g., physical pixels) is double that of a logical resolution (e.g., logical pixels), then the DPR will be 2. According to one aspect, a full map tile with a DPR of 1 may have a size of about 1 megabit (Mb), a full map tile with a DPR of 2 may have a size between 3 Mb and 4 Mb, and a full map tile with a DPR of 3 may have a size between 4 Mb and 9 Mb. Consequently, assuming for example that 1 second is a normal time for rendering one map tile, an internet connection speed of about 10 megabits per second (Mbps) (i.e., 1.25 megabytes per second (MBps)) is sufficient for a DPR of 1 and 2, but not acceptable for a DPR of 3.

For example, the evaluation module 118 may allow a maximum map tile resolution (e.g., DPR of 3 to 4) if the internet connection speed is fast (e.g., 10 Mbs), a medium map tile resolution (e.g., DPR of 2) if the internet connection speed is moderate (e.g., 5 to 10 Mbs), and a minimum map tile resolution (e.g., DPR of 1) if the internet connection speed is slow (e.g., 0 to 5 Mbps).

As another example, the evaluation module 118 may adjust the level of detail (e.g., map tile information) shown on the map tiles based on the current available memory of the device 102. For example, the evaluation module 118 may allow a maximum amount of detail (e.g., showing all buildings, labels, points of interest) on the map tile if the amount of available memory is large (e.g., 70-100%), a medium amount of detail (e.g., partially showing buildings, some labels, no points of interest) on the map tile if the amount of available memory is moderate (e.g., 40-70%), and a small amount of detail (e.g., showing no buildings, no labels, no points of interest) on the map tile if the amount of available memory is low (e.g., 0-40%). It should be noted that the evaluation module 118 may assign a level of quality (e.g., map tile resolution) and/or a level of detail (e.g., map tile information) with any number of intermediate gradations based on any one or more of the characteristics of the device 102.

After the evaluation module 118 determines the suitable map tile quality and detail levels based on the characteristics of the device 102, it may instruct the map service module 114 to apply the determined map tile quality and detail levels to any map tiles destined for the device 102. The map service module 114 may receive the instructions, apply the determined map tile quality and detail levels to the map tiles that it retrieved from the map tile database 116 for the device 102, and transmit the adjusted map tiles to the device 102. The map application module 112 may receive the adjusted map tiles, and display the adjusted map tiles to the user in the form of a map image 302 within the map webpage 300.

Further, in accordance with one aspect, the evaluation module 118 may also determine a suitable frame rate of scaling animation. For example, after the evaluation module 118 receives the assessment of the characteristics of the device 102, it may determine, based on one or more of the characteristics, a frame rate (e.g., frames per second (FPS)) of the scaling animation (i.e., zoom animation) appropriate for the device 102. For example, in accordance with one aspect, the evaluation module 118 may assign a target frame rate based on the current processor load of the device 102. For example, the evaluation module 118 may assign a maximum frame rate (e.g., 30 FPS) for the scaling animation if the processor load is low (e.g., 0-20%), a medium frame rate (e.g., 5 FPS) for the scaling animation if the processor load is moderate (e.g., 20-50%), and minimum frame rate (e.g., no animation—immediate display of desired zoom level) for the scaling animation if the processor load is high (e.g., 50-100%). It should be noted that the evaluation module 118 may assign a target frame rate having any number of intermediate gradations based on any one or more of the characteristics of the device 102.

After the evaluation module 118 determines the target frame rate for the scaling animation based on the characteristics of the device 102, it may instruct the map service module 114 to transmit to the device 102 the assigned target frame rate with instructions to have the device 102 simulate in the background a map scaling animation at the target frame rate. The map application module 112 may receive the instructions along with any requested map tiles, apply the assigned target frame rate to any scaling operations performed by the user, and simulate the scaling animation as instructed. During (e.g., in real-time) or after the simulation by the map application module 112, the map service module 114 may observe the performance of the scaling animation. For example, the map service module 114 may monitor the frame rate at which the device 102 was able to run the scaling animation. Based on the observation, the evaluation module 118 may determine whether the assigned target frame rate requires any adjustment. If so, the evaluation module 118 may adjust the target frame rate (e.g., raise or lower target FPS). For example, if the device 102 simulated the scaling animation at a frame rate that was lower than the target frame rate, then the evaluation module 118 may lower the target frame rate; whereas if the device 102 simulated the scaling animation at a frame rate that was equal to or greater than the target frame rate, then the evaluation module 118 may increase the target frame rate. Thereafter, the evaluation module 118 may instruct the map application module 112 to perform another simulation of the scaling animation using the adjusted target frame rate. This process may be repeated continuously while the user is navigating the map image 302 to ensure that the assigned target frame rate matches the actual frame rate of the map scaling animation simulation.

Accordingly, in this manner, the user of the device 102 is provided with a map service experience that is optimized based on the characteristics of the device 102.

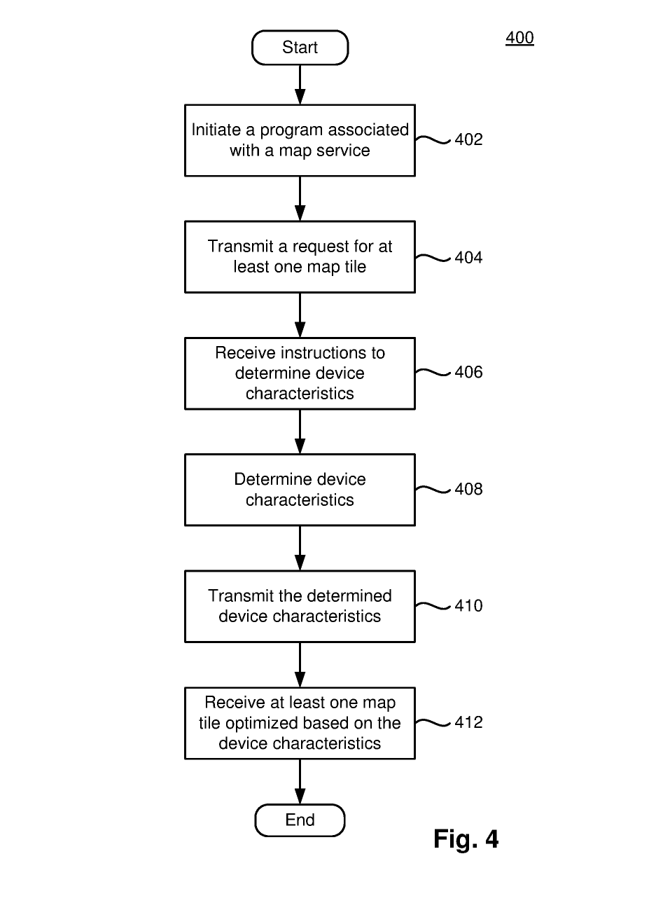

FIG. 4 is a flow diagram illustrating an example method for dynamically optimizing map tiles according to one aspect of the invention. The process described in this flow diagram may be implemented in a device accessing a map service, such as a user device 102. As shown in FIG. 4, the process 400 may begin in block 402, where a device may initiate a program associated with a map service. For example, the device 102 may activate the map application module 112 that would contact map service module 114 to request access to a map service. In block 404, the map application module 112 may transmit a request to the map service module 114 for at least one map tile. In block 406, the map application module 112 may receive instructions to determine its device characteristics, such as one or more of a processor type, total memory, graphics subsystem type, current processor load, current number of operations executed by the processor, available memory, internet connection speed, etc. In block 408, the map application module 112 may determine the characteristics of the device 102. In block 410, the map application module 112 may transmit to the map service module 114 the determined characteristics of the device 102. In block 412, the map application module 112 may receive from the map service module 114 at least one map tile that is optimized based on the characteristics of the device 102, and the process may end.

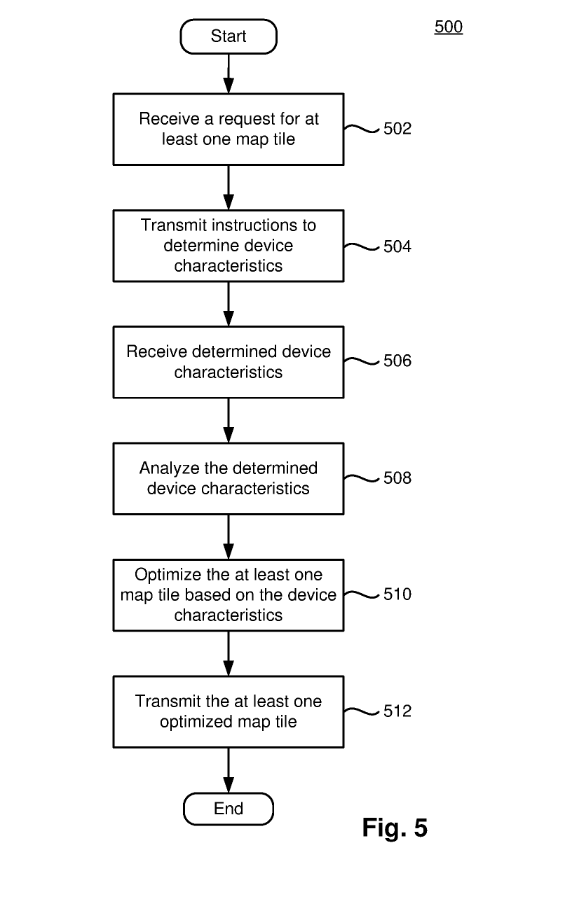

FIG. 5 is a flow diagram illustrating an example method for dynamically optimizing map tiles according to one aspect of the invention. The process 500 described in this flow diagram may be implemented in a server hosting a map service, such as map server 104. As shown in FIG. 5, the process may begin in block 502, where a server may receive a request for at least one map tile. For example, the map service module 114 of the map server 104 may receive a request from the map application module 112 of the device 102 for at least one map tile. In block 504, the map service module 114 may transmit instructions to the map application module 112 to determine characteristics of the device 102, such as one or more of a processor type, total memory, graphics subsystem type, current processor load, current number of operations executed by the processor, available memory, internet connection speed, etc. In block 506, the map service module 114 may receive the determined device characteristics from the map application module 112. In block 508, the evaluation module 118 may analyze the device characteristics and may provide instructions to the map service module 114 to adjust (e.g., optimize) the map tiles based on the analysis of the device characteristics. In block 510, the map service module 114 may optimize the at least one map tile based on the analysis of the device characteristics. In block 512, the map service module 114 may transmit the at least one optimized map tile to the map application module 112 for display on the device 102, and the process may end.

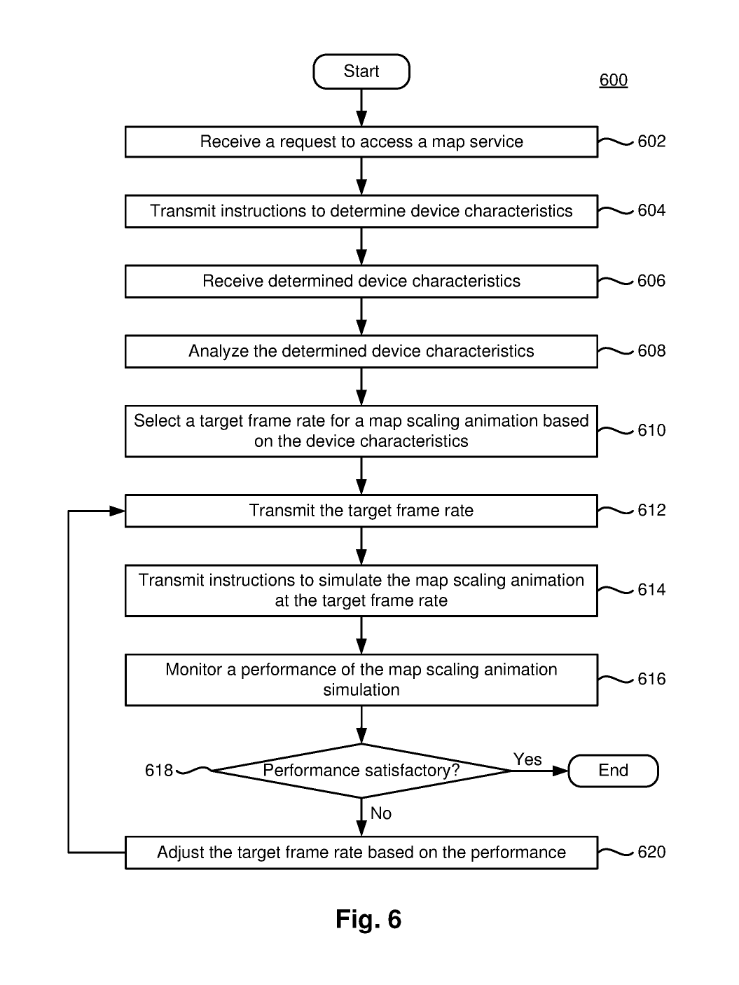

FIG. 6 is a flow diagram illustrating an example method for dynamically optimizing map scaling animation according to one aspect of the invention. The process described in this flow diagram may be implemented in a server hosting a map service, such as map server 104. As shown in FIG. 6, the process 600 may begin in block 602, where a server may receive a request to access a map service. For example, the map service module 114 of the map server 104 may receive a request from the map application module 112 of the device 102 to access the map service hosted by the map server 104. In block 604, the map service module 114 may transmit instructions to the map application module 112 to determine characteristics of the device 102, such as one or more of a processor type, total memory, graphics subsystem type, current processor load, current number of operations executed by the processor, available memory, internet connection speed, etc. In block 606, the map service module 114 may receive the determined device characteristics from the map application module 112. In block 608, the evaluation module 118 may analyze the device characteristics. In block 610, the evaluation module 118 may select a target frame rate for a map scaling animation based on the analysis of the device characteristics. In block 612, the map service module 114 may transmit the target frame rate to the map application module. In block 614, the map service module 114 may transmit instruction to the map application module 112 to simulate the map scaling animation at the target frame rate. In block 616, the map service module 114 may monitor in real-time the performance of the scaling animation simulation. For example, the map service module 114 may monitor in real-time a number of frames per second at which the device 102 is able to simulate the map scaling animation. In block 618 the evaluation module 118 may determine whether the performance of the map scaling animation simulation was satisfactory. For example, the evaluation module 118 may determine whether the assigned target frame rate requires any adjustment based on the performance of the simulation. If the map scaling animation simulation was not satisfactory, then in block 620, the evaluation module 118 may adjust the target frame rate based on the performance (e.g., lower or raise the target frame rate), and the process may proceed to block 612. If the map scaling animation simulation was satisfactory, then the process ends.

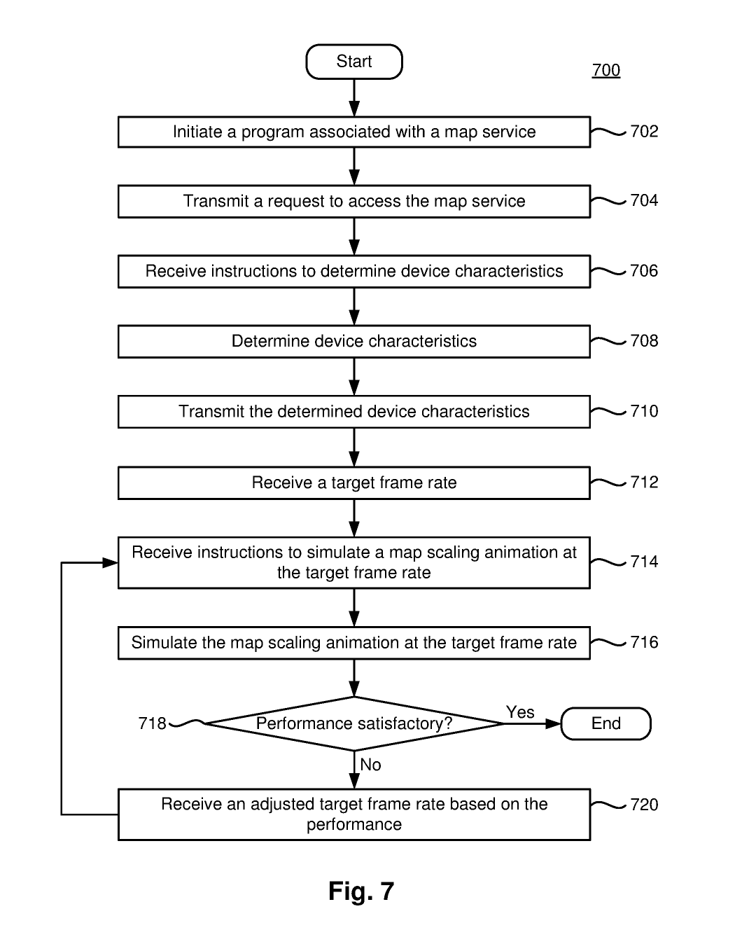

FIG. 7 is a flow diagram illustrating an example method for dynamically optimizing map scaling animation according to one aspect of the invention. The process described in this flow diagram may be implemented in a device accessing a map service, such as device 102. As shown in FIG. 7, the process 700 may begin in block 702, where a device may initiate a program associated with a map service. For example, the device 102 may activate the map application module 112 that would contact map service module 114 to request access to a map service. In block 704, the map application module 112 may transmit a request to the map service module 114 to access the map service. In block 706, the map application module 112 may receive instructions from the map service module 114 to determine its device characteristics, such as one or more of a processor type, total memory, graphics subsystem type, current processor load, current number of operations executed by the processor, available memory, internet connection speed, etc. In block 708, the map application module 112 may determine the characteristics of the device 102. In block 710, the map application module 112 may transmit to the map service module 114 the determined characteristics of the device 102. In block 712, the map application module 112 may receive from the map service module 114 a target frame rate for use in the map scaling animation. In block 714, the map application module 112 may receive instructions to simulate in the background the map scaling animation at the target frame rate. In block 716, the evaluation module 118 of the map server 104 may determine whether the results of the map scaling animation simulation were satisfactory 718. For example, the evaluation module 118 may determine whether the assigned target frame rate requires any adjustment based on the performance of the simulation. If the map scaling animation simulation was not satisfactory, then in block 720, the map application module 112 may receive an adjusted target frame rate based on the performance (e.g., lower or higher target frame rate), and the process may proceed to block 714. If the map scaling animation simulation was satisfactory, then the process ends.

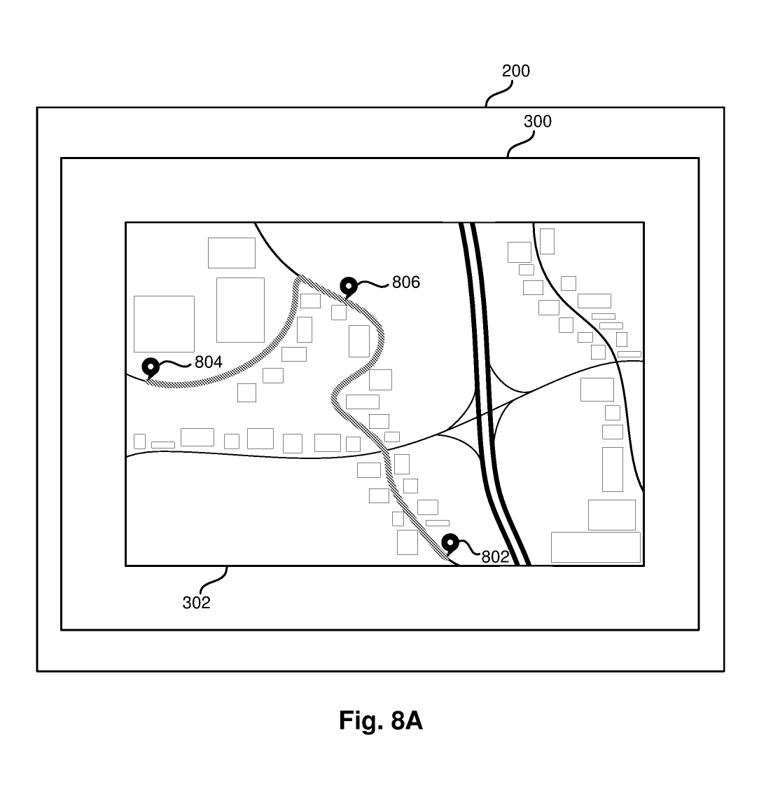

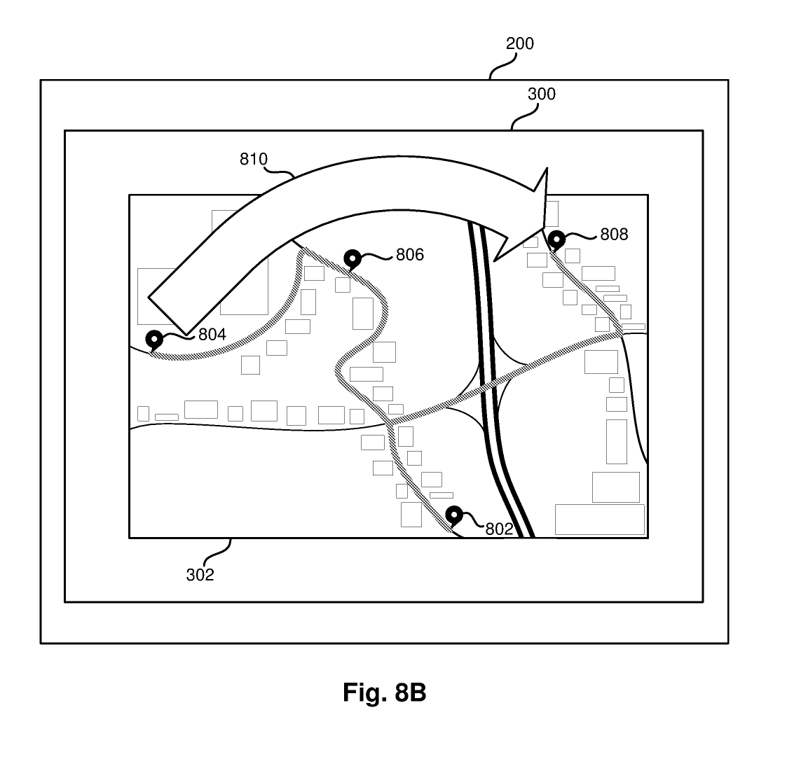

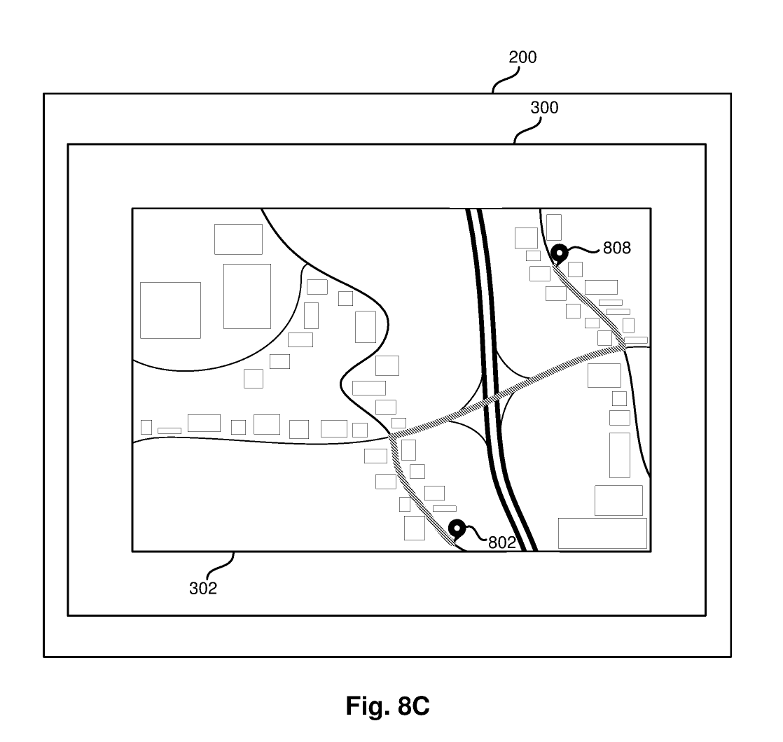

FIGS. 8A-C are diagrams illustrating an example aspect of a map webpage of a system for dynamically optimizing map destination routing performance according to one aspect of the invention. For example, if a user wishes to find out or plan a route between two locations, the user may use the map request entry webpage 202 to enter an address of a start location 802 and an end location 804. Alternatively, the user may simply select the start location 802 and the end location 804 with a mouse cursor or finger on the map image 302. The user may also enter an address for or select on the map image 302 a point of interest 806 between the start and end locations to ensure that the route would pass through the point of interest 806. After the user enters the start and end locations, the device 102 may transmit to the server 104 a request for route information from the start location 802 to the end location 804, including any points of interest selected by the user. The map service module 114 of the server 104 may receive the request and may determine a route based on the start location 802, the end location 804, and any points of interest (e.g., point of interest 806). The map service module 114 may then transmit to the device 102 route information including the route between the start location 802 and the end location 804 along with any points of interest. The map application module 112 may receive the route information and generate (e.g., render) the route on the map image 302 as shown in FIG. 8A.

Once the route is generated and displayed on the map image 302, the user may wish to change the route and may do so, for example, by selecting a new start location or end location 808 on the map image 302 or by clicking an icon representing the first start location 802 or the first end location 804 and dragging the icon across the map (as represented by arrow 810 in FIG. 8B) to a new location 808. The user may similarly drag the point of interest 806, remove the point of interest, and/or add a new point of interest. The map application module 112 may then transmit to the server 104 a request to change the route in accordance with the changes to the start or end locations and any points of interest. The map service module 114 may receive the request, determine updated route information based on the changes, and may transmit the updated route information to the map application module 112. The map application module 112 may receive the updated route information and generate the updated route on the map image 302 as shown in FIG. 8C.

According to an aspect, the map application module 112 may transmit to the server 104 one or more of the requests for updated route information, not in real-time, as they are received from the user, an assisted driving system or another computing device, but periodically at a predetermined frequency. For example, the frequency of the requests may generally correspond to an average period of time between the route information requests transmitted by the device 102 to the server 104. This period of time may include the time it may take the device 102 to receive the route information from server 104, to decode and display the route information, and to prepare a subsequent request to change the route. The time it takes to perform these functions may depend on various factors, such as the characteristics of the device 102 and other secondary characteristics, which will be discussed below. For example, to decode and display the received route information, the device 102 may first have the processing unit (e.g., CPU) process route coordinates of the route information and then have the graphics subsystem (e.g., GPU) render the route for display on the map image 302. Consequently, the time it takes the processing unit to process the route coordinates may depend on the type and power of the processing unit, and the time it takes the graphics subsystem to decode and display the route information may depend on the type and power of the graphics subsystem and the memory capacity of the device 102.

Accordingly, the evaluation module 118 of the server 104 may acquire the various characteristics and determine based on these characteristics a frequency at which the map application module 112 is to transmit the requests such that the frequency of the request transmissions is suited for the device 102 and the server 104. The evaluation module 118 may then transmit the determined frequency in a message to the device 102, instructing the map application module 112 to transmit any route information requests at the determined frequency. Because the frequency of the route information requests generally correlates to a frequency at which the route is rendered on the map image 302 (e.g., refresh rate of the route changing animation), the user of the device 102 is provided with a map and route navigation experience that is optimized for the device 102.

According to an aspect, the various characteristics that the evaluation module 118 uses to calculate the frequency may include the characteristics of the device 102 and secondary characteristics. The characteristics of the device 102 may include one or more of processor type, total memory, graphics subsystem type, current processor load, current number of operations executed by the processor, available memory, bandwidth, and internet connection speed. The secondary characteristics may include one or more of a load on the map service that is provided by the server 104, a time required for rendering (e.g., drawing) the updated route as determined by the graphics subsystem type of the device 102, a length of the updated route, and a size of the updated route information.

According to an aspect, the size of the updated route information may directly scale with a distance of the updated route as well as a number of the points of interest. Accordingly, the frequency may be based on an estimated time for the device 102 to process the size of the updated route information based at least on the current processor load of the device 102, available memory of the device 102, and a bandwidth of a connection between the device 102 and the server 104.

According to an aspect, the frequency may be based on a queue of the requests for updated route information at the server 104. The frequency may be inversely proportional to a growth of the queue at the server 104. For example, if the server 104 is experiencing a growing queue of route information requests from the device 102 (or a plurality of devices 102), then the map application module 112 may instruct the device 102 to reduce the request demand rate (i.e., reduce the frequency at which the device 102 transmits the requests). Furthermore, if the map application module 112 detects a growing request queue, the map application module 112 may discard older requests and instead respond to the newer requests so as to provide the device 102 with a quicker response to the latest alterations to the route by the user.

According to an aspect, once the map application module 112 detects that the user is rapidly changing a parameter of the route (e.g., dragging one of the location points or points of interest of the route across the map), the map application module 112 may transmit a signal to the server 104, requesting the map service module 114 to increase the frequency of the requests in order to provide a better navigation experience to the user of the device 102. The map service module 114 may receive the request, instruct the evaluation module 118 to recalculate a higher frequency, and transmit the recalculated frequency to the device 102. On the other hand, if the map application module 112 detects that the location points and points of interest are stable and are not being interacted with, the map application module 112 may transmit a signal to the server 104, requesting the map service module 114 to decrease the frequency in order to, for example, reduce information traffic between the device 102 and the server 104 as well as to conserve the battery life of the device 102. The map service module 114 may receive the request, instruct the evaluation module 118 to recalculate a lower frequency, and transmit the recalculated frequency to the device 102.

The map application module 112 may similarly request the map service module 114 to adjust the frequency in cases when the map application module 112 detects an event affecting at least one of the characteristics of the device 102 or at least one of the secondary characteristics. For example, upon detecting an event such as a new application being loaded into memory, a new background process, or a change to a different type of internet connection, the map application module 112 may determine the characteristics of the device 102 and the secondary characteristics. The map application module 112 may then transmit the determined characteristics of the device 102 and the secondary characteristics to the server 104. The map service module 114 of the server 104 may receive the updated device and secondary characteristics, instruct the evaluation module 118 to recalculate a new frequency based on the updated device and secondary characteristics, and transmit the recalculated frequency to the device 102.

According to an aspect, if the map application module 112 transmits to the server 104 a request for route information that includes a complex route (e.g., a route having many points of interests, turns, highway exits, etc.), the map service module 114 may simplify the route information it provides in response (i.e., reduce the size of the route information response), such as, for example, by reducing or removing various details from and around the route, such as traffic and parking information.

According to an aspect, the map service module 114 may also regulate a frequency at which the server 104 transmits responses to the route information requests of the device 102 as well as the size of the updated route information. For example, the evaluation module 118 may calculate a response frequency and the size of the route information based on one or more of a queue of the requests for updated route information at the server 104, a length of the updated route, a number of points of interest (POIs) on the updated route, and a quantity of the one or more requests for the updated route information.

Accordingly, in this manner, the user of the device 102 is provided with a map destination routing experience that is optimized based on various characteristics related to the device 102 and the server 104.

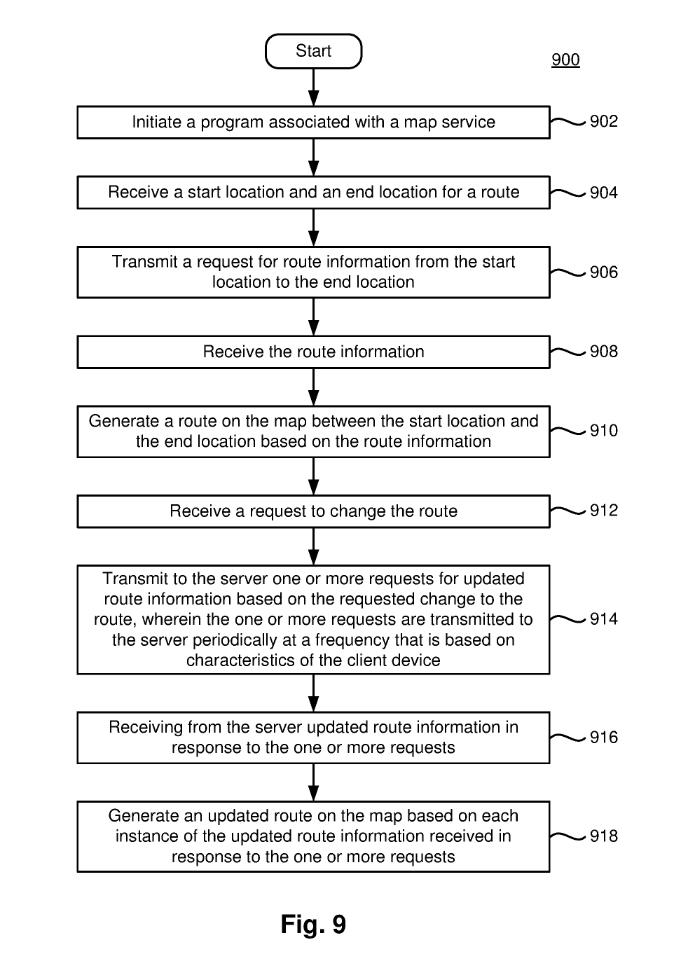

FIG. 9 is a flow diagram illustrating an example method for dynamically optimizing map destination routing according to one aspect of the invention. The process described in this flow diagram may be implemented in a device accessing a map service, such as device 102. As shown in FIG. 9, the process 900 may begin in block 902, where a device may initiate a program associated with a map service. For example, the device 102 may activate the map application module 112 that would contact map service module 114 to request access to a map service provided by the server 104. In block 904, the map application module 112 may receive a start location and an end location for a route. In block 906, the map application module 112 may transmit to the server 104 a request for route information from the start location to the end location. In block 908, the map application module 112 may receive from the server 104 the route information. In block 910, the map application module 112 may generate a route on the map between the start location and the end location based on the route information. In block 912, the map application module 112 may receive request to change the route, including at least one of a change to the start location, a change to the end location, and an addition of at least one new point of interest to the route. In block 914, the map application module may transmit to the server 104 one or more requests for updated route information based on the requested change to the route, wherein the one or more requests are transmitted to the server periodically at a frequency that is based on characteristics of the client device. In block 916, the map application module may receive from the server 104 updated route information in response to the one or more requests. In block 918, the map application module may generate an updated route on the map based on each instance of the updated route information received in response to the one or more requests.

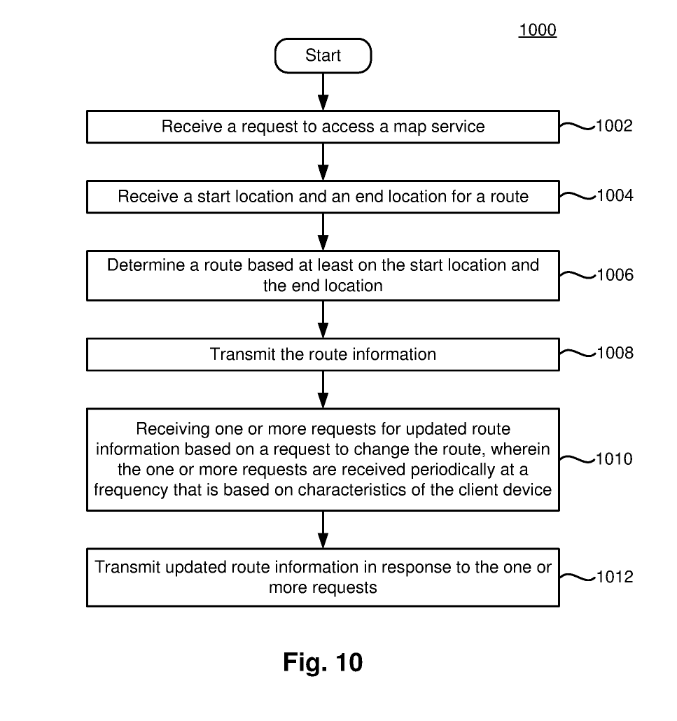

FIG. 10 is a flow diagram illustrating an example method for dynamically optimizing map destination routing according to one aspect of the invention. The process described in this flow diagram may be implemented in a server hosting a map service, such as device 104. As shown in FIG. 10, the process 1000 may begin in block 1002, where map service module 114 of the sever 104 may receive from the client device 102 a request to access a map service including an interactive map. In block 1004, the map service module 114 may receive from the client device 102 at least a start location and an end location for a route. In block 1006, the map service module 114 may determine a route based at least on the start location and the end location. In block 1008, the map service module 114 may transmit to the client device 102 the route information, wherein the route information facilitates the generation of the route on the map between the start location and the end location. In block 1010, the map service module 114 may receive from the client device 102 one or more requests for updated route information based on a request to change the route, including at least one of a change to the start location, a change to the end location, and an addition of at least one new point of interest to the route, wherein the one or more requests are received periodically at a frequency that is based on characteristics of the client device 102. For example, the frequency may be determined by the evaluation module 118 of the server based on device characteristics and other secondary characteristics associated with both the device 102 and the server 104. In block 1012, the map service module 114 may transmit to the client device 102 updated route information in response to the one or more requests.

FIG. 11 depicts one example aspect of a computer system 5 that may be used to implement the disclosed systems and methods for dynamically optimizing map service performance according to one aspect of the invention. The computer system 5 may include, but not limited to, a personal computer, a notebook, tablet computer, a smart phone, a mobile device, a network server, a router, or other type of processing device. As shown, computer system 5 may include one or more hardware processors 15, memory 20, one or more hard disk drive(s) 30, optical drive(s) 35, serial port(s) 40, graphics card 45, audio card 50 and network card(s) 55 connected by system bus 10. System bus 10 may be any of several types of bus structures including a memory bus or memory controller, a peripheral bus and a local bus using any of a variety of known bus architectures. Processor 15 may include one or more Intel® Core 2 Quad 2.33 GHz processors or other type of microprocessor.

System memory 20 may include a read-only memory (ROM) 21 and random access memory (RAM) 23. Memory 20 may be implemented as in DRAM (dynamic RAM), EPROM, EEPROM, Flash or other type of memory architecture. ROM 21 stores a basic input/output system 22 (BIOS), containing the basic routines that help to transfer information between the modules of computer system 5, such as during start-up. RAM 23 stores operating system 24 (OS), such as Windows® 7 Professional or other type of operating system, that is responsible for management and coordination of processes and allocation and sharing of hardware resources in computer system 5. Memory 20 also stores applications and programs 25. Memory 20 also stores various runtime data 26 used by programs 25.

Computer system 5 may further include hard disk drive(s) 30, such as SATA HDD, and optical disk drive(s) 35 for reading from or writing to a removable optical disk, such as a CD-ROM, DVD-ROM or other optical media. Drives 30 and 35 and their associated computer-readable media provide non-volatile storage of computer readable instructions, data structures, applications and program modules/subroutines that implement algorithms and methods disclosed herein. Although the exemplary computer system 5 employs magnetic and optical disks, it should be appreciated by those skilled in the art that other types of computer readable media that can store data accessible by a computer system 5, such as magnetic cassettes, flash memory cards, digital video disks, RAMs, ROMs, EPROMs and other types of memory may also be used in alternative aspects of the computer system 5.

Computer system 5 further includes a plurality of serial ports 40, such as Universal Serial Bus (USB), for connecting data input device(s) 75, such as keyboard, mouse, touch pad and other. Serial ports 40 may be also be used to connect data output device(s) 80, such as printer, scanner and other, as well as other peripheral device(s) 85, such as external data storage devices and the like. System 5 may also include graphics card 45, such as nVidia® GeForce® GT 240M or other video card, for interfacing with a display 60 or other video reproduction device, such as touch-screen display. System 5 may also include an audio card 50 for reproducing sound via internal or external speakers 65. In addition, system 5 may include network card(s) 55, such as Ethernet, WiFi, GSM, Bluetooth or other wired, wireless, or cellular network interface for connecting computer system 5 to network 70, such as the Internet.

In various aspects, the systems and methods described herein may be implemented in hardware, software, firmware, or any combination thereof. If implemented in software, the methods may be stored as one or more instructions or code on a non-transitory computer-readable medium. Computer-readable medium includes data storage. By way of example, and not limitation, such computer-readable medium can comprise RAM, ROM, EEPROM, CD-ROM, Flash memory or other types of electric, magnetic, or optical storage medium, or any other medium that can be used to carry or store desired program code in the form of instructions or data structures and that can be accessed by a processor of a general purpose computer.

In the interest of clarity, not all of the routine features of the aspects are disclosed herein. It will be appreciated that in the development of any actual implementation of the invention, numerous implementation-specific decisions must be made in order to achieve the developer's specific goals, and that these specific goals will vary for different implementations and different developers. It will be appreciated that such a development effort might be complex and time-consuming, but would nevertheless be a routine undertaking of engineering for those of ordinary skill in the art having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for dynamically optimizing map destination routing performance, comprising:
initiating on a client device a program associated with a map service including an interactive map, wherein the map service is provided at least in part by a server;
receiving at least a start location and an end location for a route;
transmitting to the server a request for route information from the start location to the end location;
receiving from the server the route information;
generating a route on the map between the start location and the end location based on the route information;
receiving a request to change the route, including at least one of a change to the start location, a change to the end location, and an addition of at least one new point of interest to the route;
transmitting to the server one or more requests for updated route information based on the requested change to the route, wherein the one or more requests are transmitted to the server periodically at a frequency that is based on characteristics of the client device, the characteristics of the client device including periodically generated static and dynamic characteristics of the client device, (i) static characteristics including one or more of processor type, total memory, graphics subsystem type, and (ii) dynamic characteristics including one or more of current processor load, current number of operations executed by the processor, available memory, and internet connection speed;
receiving from the server updated route information in response to the one or more requests; and
generating an updated route on the map based on each instance of the updated route information received in response to the one or more requests.

2. (canceled)

3. The method of claim 1, wherein the frequency is further based on secondary characteristics including one or more of a load on the map service that is provided by the server, a time required for drawing the updated route as determined by the graphics subsystem type, a length of the updated route, a size of the updated route information.

4. The method of claim 3, wherein the frequency is further based on a size of the updated route information that directly scales with a distance of the updated route.

5. The method of claim 4, wherein the frequency is further based on an estimated time for the client device to process the size of the updated route information based at least on the current processor load of the client device, available memory of the client device, and a bandwidth of a connection between the client device and the server.

6. The method of claim 1, wherein the frequency is further based on a queue of the requests for updated route information at the server, wherein the frequency is inversely proportional to a growth of the queue.

7. The method of claim 3, wherein the frequency is determined by the server based on the characteristics of the client device and the secondary characteristics.

8. The method of claim 7, further comprising:
detecting an event affecting at least one of the characteristics of the client device or at least one of the secondary characteristics;
determining the characteristics of the client device and the secondary characteristics upon detection of the event; and
transmitting the determined characteristics of the client device and the secondary characteristics to the server.

9. The method of claim 8, wherein the event includes one or more of a new application being loaded into memory, a new background process, and a change to a different type of internet connection.

10. A system for dynamically optimizing map destination routing performance, comprising:
a map application module executable by a processor of a client device and configured to:
initiate on the client device a program associated with a map service including an interactive map, wherein the map service is provided at least in part by a server;
receive at least a start location and an end location for a route;
transmit to the server a request for route information from the start location to the end location;
receive from the server the route information;
generate a route on the map between the start location and the end location based on the route information;
receive a request to change the route, including at least one of a change to the start location, a change to the end location, and an addition of at least one new point of interest to the route;
transmit to the server one or more requests for updated route information based on the requested change to the route, wherein the one or more requests are transmitted to the server periodically at a frequency that is based on characteristics of the client device, the characteristics of the client device including periodically generated static and dynamic characteristics of the client device, (i) static characteristics including one or more of processor type, total memory, graphics subsystem type, and (ii) dynamic characteristics including one or more of current processor load, current number of operations executed by the processor, available memory, and internet connection speed;
receive from the server updated route information in response to the one or more requests; and
generate an updated route on the map based on each instance of the updated route information received in response to the one or more requests.

11. (canceled)

12. The system of claim 10, wherein the frequency is further based on secondary characteristics including one or more of a load on the map service that is provided by the server, a time required for drawing the updated route as determined by the graphics subsystem type, a length of the updated route, a size of the updated route information.

13. The system of claim 12, wherein the frequency is further based on a size of the updated route information that directly scales with a distance of the updated route.

14-15. (canceled)

16. A method for dynamically optimizing map destination routing performance, comprising:
receiving, by a server, from a client device a request to access a map service including an interactive map;
receiving from the client device at least a start location and an end location for a route;
determining a route based at least on the start location and the end location;
transmitting to the client device the route information, wherein the route information facilitates the generation of the route on the map between the start location and the end location;
receiving from the client device one or more requests for updated route information based on a request to change the route, including at least one of a change to the start location, a change to the end location, and an addition of at least one new point of interest to the route, wherein the one or more requests are received periodically at a frequency that is based on characteristics of the client device, the characteristics of the client device including periodically generated static and dynamic characteristics of the client device, (i) static characteristics including one or more of processor type, total memory, graphics subsystem type, and (ii) dynamic characteristics including one or more of current processor load, current number of operations executed by the processor, available memory, and internet connection speed; and
transmitting to the client device updated route information in response to the one or more requests, wherein at least one of a size of the updated route information and a frequency at which the updated route information is transmitted to the client device is based on one or more of a queue of the requests for updated route information at the server, a length of the updated route, a number of points of interest (POIs) on the updated route, and a quantity of the one or more requests for the updated route information.

17. (canceled)

18. The method of claim 17, wherein the frequency is further based on secondary characteristics including one or more of a load on the map service that is provided by the server, a time required for drawing the updated route as determined by the graphics subsystem type, a length of the updated route, a size of the updated route information.

19. The method of claim 18, wherein the frequency is further based on a size of the updated route information that directly scales with a distance of the updated route.

20. The method of claim 19, wherein the frequency is further based on an estimated time for the client device to process the size of the updated route information based at least on the current processor load of the client device, available memory of the client device, and a bandwidth of a connection between the client device and the server.

21. The method of claim 16, wherein the frequency is further based on a queue of the requests for updated route information at the server, wherein the frequency is inversely proportional to a growth of the queue.

22. The method of claim 18, wherein the frequency is determined by the server based on the characteristics of the client device and the secondary characteristics.

23. The method of claim 22, further comprising:
receiving from the client device updated characteristics in response to a detected event affecting at least one of the characteristics of the client device or at least one of the secondary characteristics.

24. The method of claim 23, wherein the event includes one or more of a new application being loaded into memory, a new background process, a change to a different type of internet connection.

25. A system for dynamically optimizing map destination routing performance, comprising:
a map service module executable by a processor of a server and configured to:
receive from a client device a request to access a map service including an interactive map;
receive from the client device at least a start location and an end location for a route;
determine a route based at least on the start location and the end location;
transmit to the client device the route information, wherein the route information facilitates the generation of the route on the map between the start location and the end location;
receive from the client device one or more requests for updated route information based on a request to change the route, including at least one of a change to the start location, a change to the end location, and an addition of at least one new point of interest to the route, wherein the one or more requests are received periodically at a frequency that is based on characteristics of the client device, the characteristics of the client device including periodically generated static and dynamic characteristics of the client device, (i) static characteristics including one or more of processor type, total memory, graphics subsystem type, and (ii) dynamic characteristics including one or more of current processor load, current number of operations executed by the processor, available memory, and internet connection speed; and
transmit to the client device updated route information in response to the one or more requests, wherein at least one of a size of the updated route information and a frequency at which the updated route information is transmitted to the client device is based on one or more of a queue of the requests for updated route information at the server, a length of the updated route, a number of points of interest (POIs) on the updated route, and a quantity of the one or more requests for the updated route information.

26-30. (canceled)
